(19) United States
(12) Patent Application Publication
(10) Pub. No.: US 2022/0087469 A1
(43) Pub. Date: Mar. 24, 2022

(54) WATER OUTLET DEVICE AND AUTOMATIC WATER DISPENSER HAVING THE SAME

(71) Applicant: Tsann Kuen (Zhangzhou) Enterprise Co., Ltd., Zhangzhou (CN)

(72) Inventors: Yanzhang HUANG, Zhangzhou (CN); Te-Keng HSU, Zhangzhou (CN); Yanxiang ZHANG, Zhangzhou (CN)

(73) Assignee: Tsann Kuen (Zhangzhou) Enterprise Co., Ltd., Zhangzhou (CN)

(21) Appl. No.: 17/478,426

(22) Filed: Sep. 17, 2021

(30) Foreign Application Priority Data
Sep. 22, 2020 (CN) 202010998632.7
Apr. 15, 2021 (CN) 202110404699.8

(51) Int. Cl. A47J 31/46; A47J 31/52; A47J 31/06; A47J 31/44

(52) U.S. Cl. CPC A47J 31/46; A47J 31/525; A47J 31/446; A47J 31/4407; A47J 31/0615

(57) ABSTRACT

A water outlet device includes a containment unit including a containment seat for containing liquid and having a water outlet hole, and a stopper movably disposed in the water outlet hole and capable of blocking the water outlet hole for preventing the liquid from flowing out thereof. A water outlet gate unit is disposed below the containment unit and includes a drive member that drives the stopper to move between a water stop position to block the water outlet hole and a water discharge position for allowing the liquid to flow through the water outlet hole. An automatic water dispenser having the water outlet device is also disclosed.

### CROSS-REFERENCE TO RELATED APPLICATION

This application claims priority to Chinese Patent Application No. 202010998632.7, filed on Sep. 22, 2020, and Chinese Patent Application No. 202110404699.8, filed on Apr. 15, 2021.

### FIELD

The disclosure relates to a water outlet device and an automatic water dispenser having the same.

### BACKGROUND

The advantages of a commercially available electric thermo pot resides in that it can provide users with hot water anytime, and its operation only involves pressing downward a water supply button on an operation panel thereof. The electric thermo pot will heat water contained therein, and after the water is heated to a target temperature, hot water can be discharged from the electric thermo pot.

However, the aforesaid electric thermo pot does not have a mechanism for temporarily storing the heated water and for brewing a brewable product. If the user wants to drink tea or coffee or other beverages, the water must be discharged first from the electric thermo pot to another container for brewing the brewable product, which is complicated to use. Hence, there is still room for improvement of the aforesaid electric thermo pot.

### SUMMARY

Therefore, an object of the present disclosure is to provide a water outlet device that is capable of overcoming at least one of the drawbacks of the prior art.

Accordingly, a water outlet device of this disclosure is suitable for containing and discharging liquid, and includes a containment unit and a water outlet gate unit. The containment unit includes a containment seat for containing the liquid and having a bottom portion formed with a water outlet hole, and a stopper located in the containment seat and movably disposed in the water outlet hole. The stopper is capable of blocking the water outlet hole for preventing the liquid from flowing out of the water outlet hole. The water outlet gate unit is disposed below the containment unit and includes a drive member that drives the stopper to move between a water stop position, in which the stopper blocks the water outlet hole, and a water discharge position, in which the stopper is moved away from the water outlet hole for allowing the liquid to flow through the water outlet hole.

Another object of the present disclosure is to provide an automatic water dispenser having the above water outlet device.

Accordingly, an automatic water dispenser of this disclosure is suitable for containing and discharging liquid, and includes a housing, a water supply device and the above water outlet device. The housing includes a main body seat portion, a main body cover portion disposed on a top end of the main body seat portion, a removable seat portion removably mounted on the main body cover portion, and a top cover assembly covering a top end of the removable seat portion. The top cover assembly includes a top cover having a plurality of water injection holes provided on a bottom surface thereof.

The water supply device includes a water storage unit disposed in the main body seat portion for containing the liquid, and a water delivery unit connected to the water storage unit and the top cover for delivering the liquid from the water storage unit to the top cover. The water outlet device is disposed in the housing, and the containment unit thereof is removably disposed in the removable seat portion. The water injection holes in the top cover are configured for injecting the liquid to the water outlet device.

### BRIEF DESCRIPTION OF THE DRAWINGS

Other features and advantages of the disclosure will become apparent in the following detailed description of the embodiments with reference to the accompanying drawings, of which:

FIG. 1 is a perspective view of an automatic water dispenser according to the first embodiment of the present disclosure;

FIG. 2 is a front sectional view of the first embodiment;

FIG. 3 is a partly fragmentary exploded perspective view of the first embodiment;

FIG. 4 is a side sectional view of the first embodiment;

FIG. 5 is a fragmentary front sectional view of the first embodiment, illustrating a stopper in a water stop position;

FIG. 6 is a view similar to FIG. 5, but illustrating the stopper in a water discharge position;

FIG. 7 is a fragmentary rear sectional view of an automatic water dispenser according to the second embodiment of the present disclosure, illustrating a rotating member located in a minimum rotation position;

FIG. 8 is a view similar to FIG. 7, but illustrating the rotating member located in a maximum rotation position;

FIG. 9 is a fragmentary side sectional view of an automatic water dispenser according to the third embodiment of the present disclosure; and

FIG. 10 is a view similar to FIG. 9, but illustrating how a drive member can drive the stopper to move by magnetic attraction.

### DETAILED DESCRIPTION

Before the present disclosure is described in greater detail, it should be noted herein that like elements are denoted by the same reference numerals throughout the disclosure.

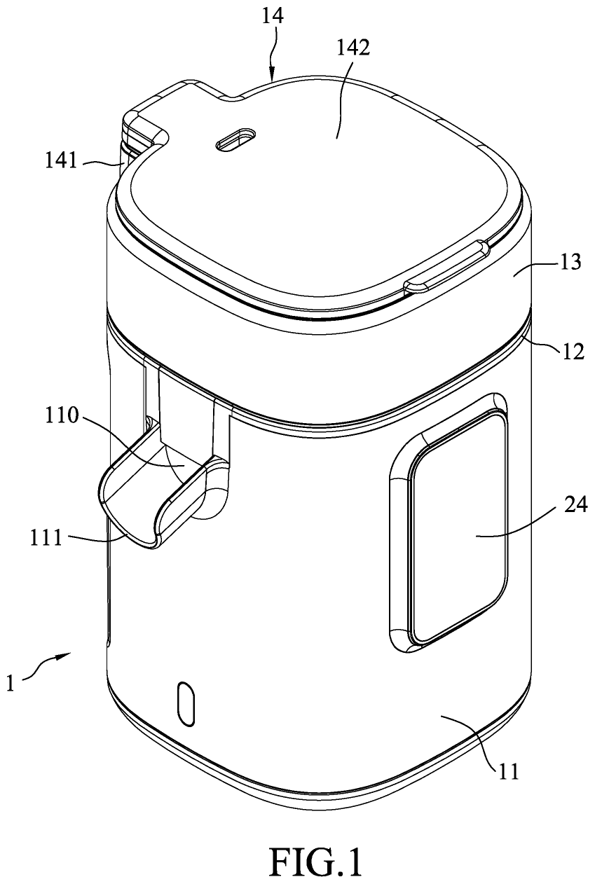

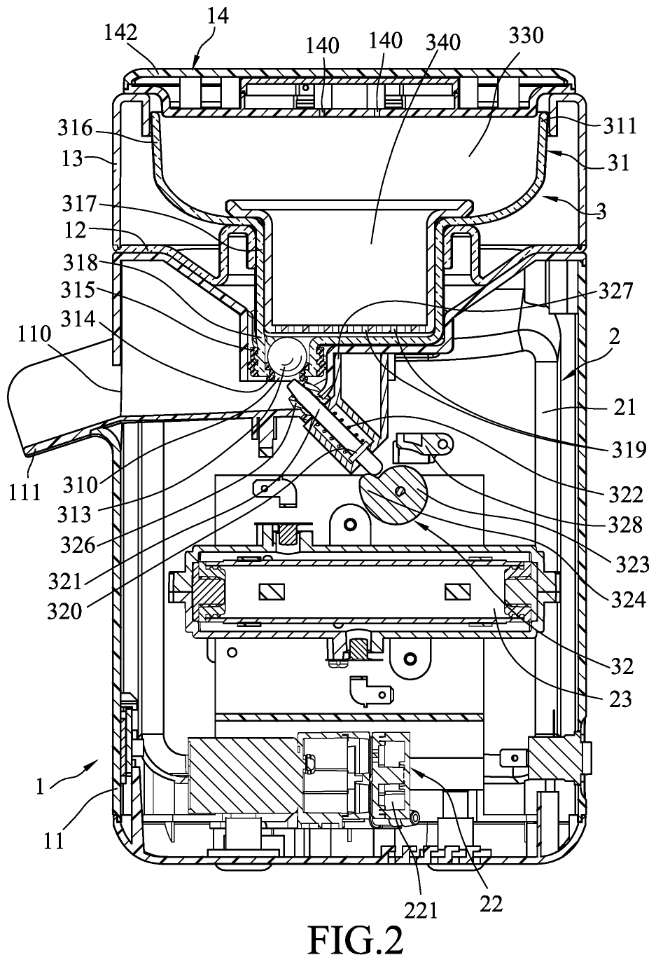

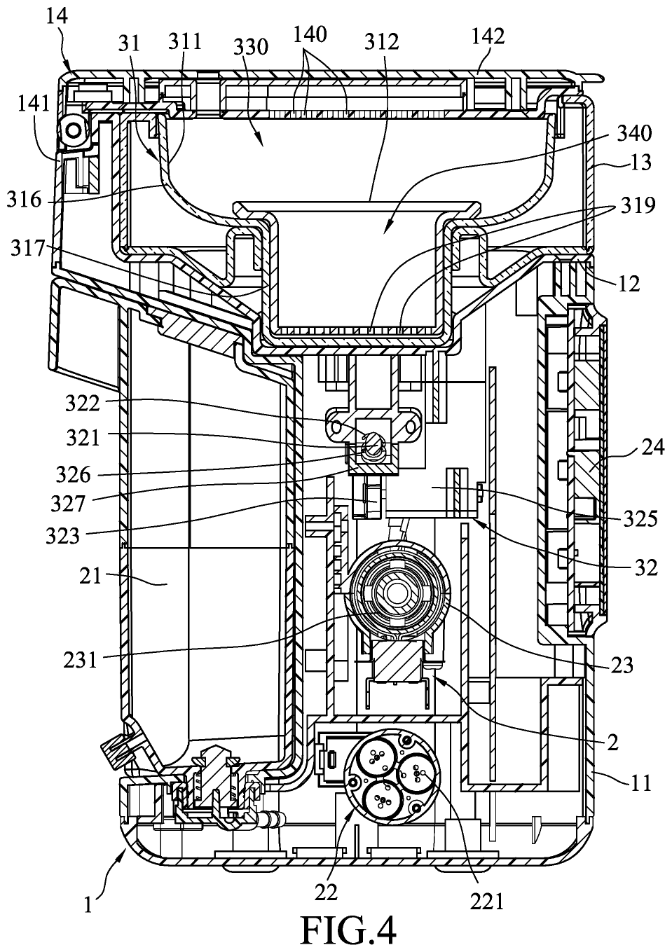

Referring to FIGS. 1 to 4, an automatic water dispenser according to the first embodiment of the present disclosure is suitable for containing liquid and for discharging a brewed beverage after the liquid is mixed with a brewable product (not shown). In this embodiment, the liquid is water. The automatic water dispenser of the first embodiment includes a housing 1, a water supply device 2, and a water outlet device 3.

The housing 1 includes a main body seat portion 11 configured to be placed on a flat surface, a main body cover portion 12 disposed on a top end of the main body seat portion 11, a removable seat portion 13 removably mounted on top of the main body cover portion 12, and a top cover assembly 14 covering a top end of the removable seat portion 13. The main body seat portion 11 has a water outflow passage 111 extending from inside to outside thereof, and a water outlet opening 110 formed in a lateral side of the main body seat portion 11 and communicating with the water outflow passage 111 for allowing the liquid to flow therethrough.

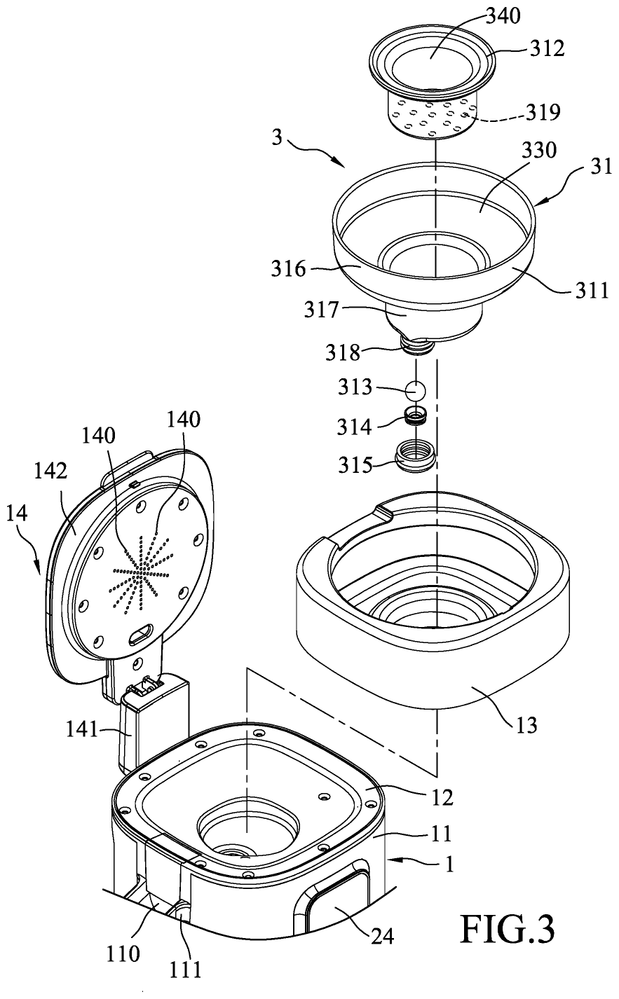

The top cover assembly 14 includes a fixing support 141 connected to a rear side of the main body seat portion 11, and a top cover 142 pivotally connected to a top side of the fixing support 141. The top cover 142 is pivotable relative to the fixing support 141 between a closed position (see FIG. 1) that covers the top end of the removable seat portion 13 and an open position (see FIG. 3) that uncovers the top end of the removable seat portion 13. A bottom surface of the top cover 142 is provided with a plurality of water injection holes 140 for injecting the liquid to the water outlet device 3. It should be noted herein that the number of the water injection holes 140 is not limited, and may be one only. That is, the number of the water injection holes 140 may be adjusted according to actual requirements.

The water supply device 2 is disposed in the housing 1, and includes a water storage unit 21 disposed in the main body seat portion 11 for containing the liquid, a heating unit 23 disposed in the main body seat portion 11 for raising the temperature of the liquid, a water delivery unit 22 connected to the water storage unit 21, the heating unit 23 and the top cover 142, and a control unit 24 mounted on a front side of the main body seat portion 11 and electrically connected to the heating unit 22, the water delivery unit 22 and the water outlet device 3.

The heating unit 23 is provided with a heating tube 231. When the heating tube 231 is energized, heat energy is generated to increase the temperature of the liquid flowing through the heating tube 231. However, there are many ways to heat the liquid, a detailed description thereof is omitted herein. The heating unit 23 is not limited to what is disclosed herein.

The water delivery unit 22 includes a pressurized motor 223 disposed in the main body seat portion 11, and a water pipeline (not shown) connected to the water storage unit 21, the heating unit 23 and the top cover 142. The liquid in the water storage unit 21 can flow out through the water pipeline, and water pressure of the liquid is increased by the pressurized motor 221, so that the liquid is delivered upward to the top cover 142 through the heating unit 23. However, there are many ways to deliver the liquid from the water storage unit 21 to the top cover 142, a detailed description thereof is omitted herein. The water delivery unit 22 is not limited to what is disclosed herein.

The control unit 24 of this embodiment is a touch panel, and can separately switch the energization state of the heating unit 23, the water delivery unit 22 and the water outlet device 3 so as to control the temperature and delivery status of the liquid. However, there are many ways to switch the energization state of the heating unit 23, the water delivery unit 22 and the water outlet device 3, and one of which may include a plurality of pushbutton switches separately provided on the main body seat portion 11, so that a detailed description thereof is omitted herein. The control unit 24 is not limited to what is disclosed herein.

The water outlet device 3 is disposed in the housing 1, and is connected to the water supply device 2. The water outlet device 3 includes a containment unit 31 removably disposed on the removable seat portion 13, and a water outlet gate unit 32 disposed below the containment unit 31 and located in the main body seat portion 11. The containment unit 31 includes a containment seat 311 for containing the liquid flowing out of the water injection holes 140 and having a bottom portion formed with a water outlet hole 310, a filter 312 disposed in the containment seat 311, a stopper 313 located in the containment seat 311 and movably disposed in the water outlet hole 310, a sealing ring 314 disposed on the bottom portion of the containment seat 311, and a waterproof ring 315 disposed between the containment seat 311 and the main body seat portion 11.

The containment seat 311 has a large diameter portion 316, a small diameter portion 318 opposite to the large diameter portion 316, and a middle diameter portion 317 gradually tapering from the large diameter portion 316 to the small diameter portion 318. The large diameter portion 316, the middle diameter portion 317 and the small diameter portion 318 cooperatively define a containment space 330 for containing the liquid. The water outlet hole 310 is formed in a bottom end of the small diameter portion 318 for the liquid to flow out of the containment seat 311. The small diameter portion 318 is connected to the top side of the main body seat portion 11.

The filter 312 of this embodiment has a cup shape, and is disposed in and abuts against an inner wall surface of the middle diameter portion 317. The filter 312 defines a brewing space 340 for selectively receiving a brewable product (not shown), and has a plurality of filter holes 319 formed in a bottom portion thereof. The filter holes 319 can allow the liquid to pass therethrough, but not the brewable product, so that the brewable product is prevented from flowing out along with the liquid. It should be noted herein that the pore size of the filter holes 319 is not limited, and may be adjusted according to actual requirements.

The sealing ring 314 of this embodiment is disposed on an inner periphery of the bottom end of the small diameter portion 318 that defines the water outlet hole 310.

The stopper 313 of this embodiment is disposed in the small diameter portion 318, and is a spherical body having a diameter larger than a hole diameter of the water outlet hole 310. When the stopper 313 is located in the water outlet hole 310, it can block the liquid from flowing through the water outlet hole 310. Further, the stopper 313 can abut against and stop at the top of the sealing ring 314 to prevent the liquid from leaking out of a gap between the stopper 313 and the small diameter portion 318. The stopper 313 is not limited to the spherical body, and may be an elliptical, an inverted conical, or other geometric body, and may be adjusted according to actual requirements.

The waterproof ring 315 is sleeved on an outer periphery of the small diameter portion 318, and is located between the small diameter portion 318 and the top side of the main body seat portion 11 to prevent the liquid flowing out of the water outlet hole 310 from entering a gap between the small diameter portion 318 and the top side of the main body seat portion 11 when it flows in a counter direction. Further, the waterproof ring 315 can also increase friction between the small diameter portion 318 and the top side of the main body seat portion 11, so that the overall structure is more stable.

The water outflow passage 111 is located below the water outlet hole 310 for receiving the liquid flowing out of the water outlet hole 310 and allowing the liquid to flow out of the housing 1 through the water outlet opening 110.

The water outlet gate unit 32 includes a fixed frame 327 located in the main body seat portion 11, a drive member 321 having top and bottom ends extending through the fixed frame 327, an abutment ring 320 sleeved on an outer periphery of the drive member 321 and located in the fixed frame 327, an impermeable member 326 disposed between the top end of the drive member 321 and the water outflow passage 111, an elastic member 322 that is sleeved on the outer periphery of the drive member 321, that is located in the fixed frame 327 and that has two opposite ends respectively abutting against the fixed frame 327 and the abutment ring 320, a rotating member 323 abutting against the bottom end of the drive member 321, a pivot motor 325 electrically connected to the control unit 24, and a start switch 328 for controlling the pivot motor 325. The elastic member 322 is a compression spring. In this embodiment, the drive member 321 is a push rod, and the start switch 328 is a micro switch, but are not limited thereto, and may be changed according to actual requirements.

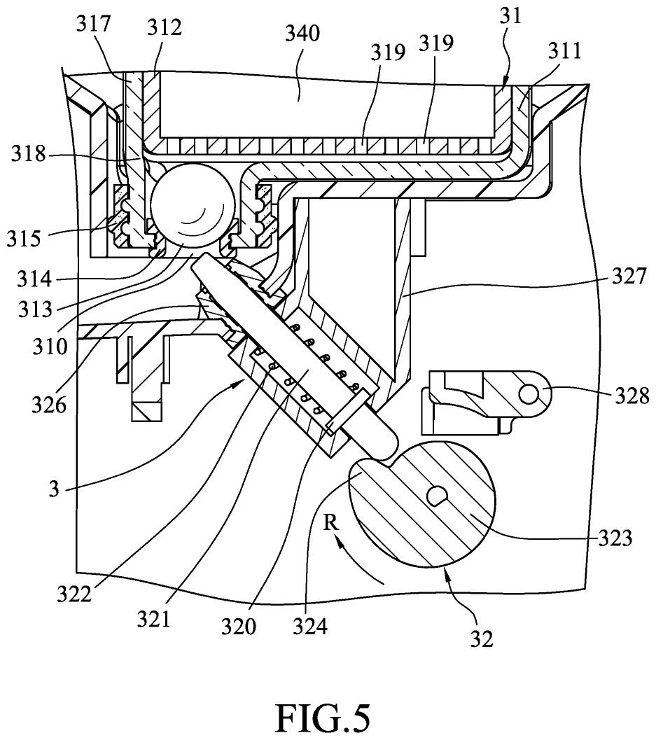

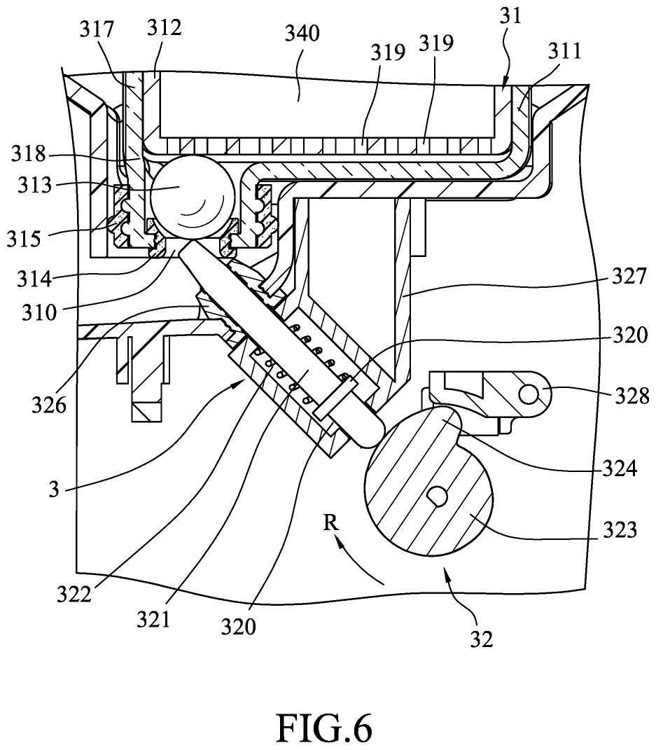

Referring to FIGS. 5 and 6, the rotating member 323 has a cylindrical shape, and has a protruding portion 324 protruding from an outer periphery thereof and abuttable against the bottom end of the drive member or push rod 321. The rotating member 323 is pivotally connected to the pivot motor 325, and can be driven by the pivot motor 325 to rotate in a rotational direction (R). When the rotating member 323 rotates in the rotational direction (R), the protruding portion 324 thereof pushes upward the push rod 321, which in turn, pushes the stopper 313 to move from a water stop position that blocks the water outlet hole 310 to a water discharge position that moves away from the water outlet hole 310.

Moreover, when the start switch 328 is controlled to be turned on by the control unit 24, the pivot motor 325 will be adjusted to an energized state and will drive the rotating member 323 to rotate in the rotational direction (R). At this time, the push rod 321 will gradually move toward the stopper 313, and the elastic member 322 is compressed by the abutment ring 320 and the fixed frame 327 to store an elastic restoring force. When the protruding portion 324 of the rotating member 323 pushes the push rod 321 to a high point, the protruding portion 324 abuts against the start switch 328, and the start switch 328 will transmit an electrical signal to the pivot motor 325 to shift the pivot motor 325 to a de-energized state so as to stop rotation of the rotating member 323. Thus, the stopper 313 stays at the water discharge position that allows the liquid to flow out of the water outlet hole 310.

Additionally, the start switch 328 can again be controlled by the control unit 24 to be turned on to shift the pivot motor 325 to the energized state so as to cause the rotating member 323 to continuously rotate in the rotational direction (R) or to rotate a direction opposite to the rotational direction (R), so that the protruding portion 324 moves away from the push rod 321, and the push rod 321 is biased to move downward through the elastic restoring force of the elastic member 322, thereby shifting the stopper 313 from the water discharge position to the water stop position.

The impermeable member 326 can prevent the liquid from flowing into the main body seat portion 11 through a gap between the push rod 321 and the water outflow passage 111. It should be noted that, since there are many ways to push the push rod 321, the shape of the rotating member 323 is not limited, and may be adjusted according to actual requirements.

To use this disclosure, a sufficient amount of the liquid is first added into the water storage unit 21, and a desired brewable product (not shown) is then placed in the brewing space 340. Next, the control unit 24 is operated to cause the water delivery unit 22 to deliver the liquid from the water storage unit 21 to the top cover 142. During delivery, the liquid is heated by the heating unit 23 to increase the temperature thereof.

Subsequently, the liquid in the top cover 142, which is hot, flows through the water injection holes 140 into the containment space 330, and then gradually flows into the brewing space 340 so as to brew the brewable product in the high temperature liquid for a period of time. After a suitable time, the control unit 24 is operated to move the stopper 313 from the water stop position to the water discharge position, allowing brewed beverage to flow out of the containment space 330 through the water outlet hole 310, and then to flow along the water outflow passage 111 passing through the water outlet opening 110 and out of the housing 1. The discharge of the brewed beverage is thus completed.

It should be noted herein that, when there is no brewable product placed in the brewing space 340, only hot water will flow out of the housing 1.

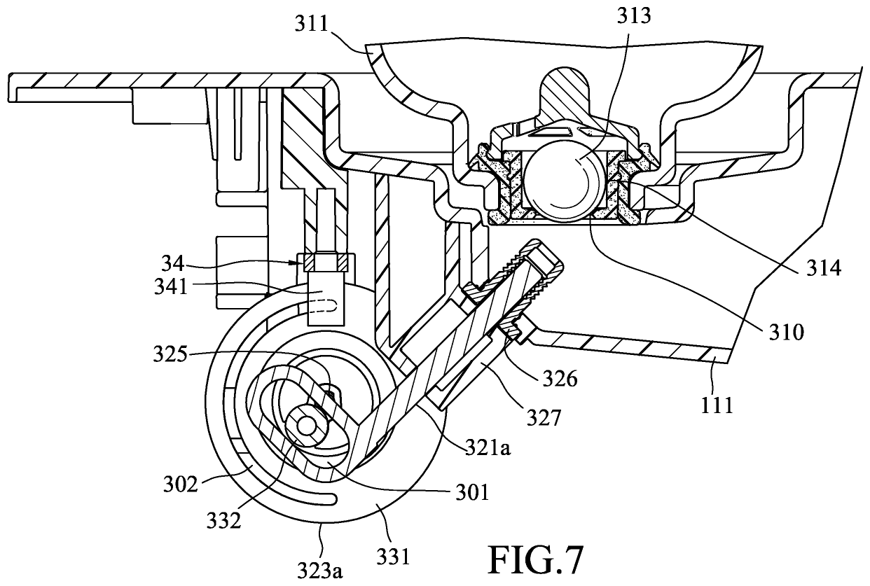

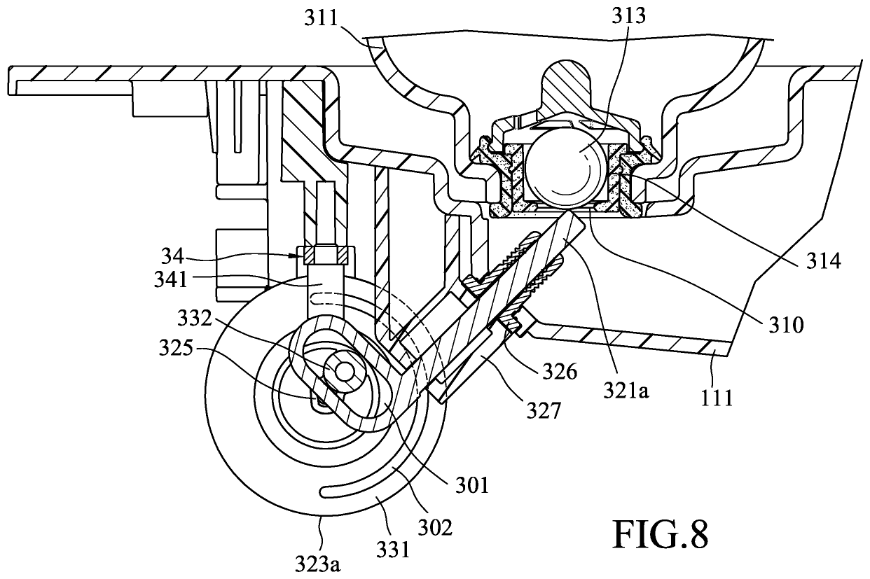

Referring to FIGS. 7 and 8, the second embodiment of the automatic water dispenser according to this disclosure is substantially identical to the first embodiment. Particularly, the water outlet gate unit 32 includes a drive member (321a), a rotating member (323a), a pivot motor 325, an impermeable member 326, and a fixed frame 327. However, in the second embodiment, the drive member (321a) has a cylindrical shape, and has a bottom end provided with a through slot 301. Further, the rotating member (323a) has a circular disk shape, and has a turntable portion 331, and a driven portion 332 protruding axially from the turntable portion 331 and hooked to the through slot 301. The turntable portion 331 has an arc-shaped groove 302 extending axially therethrough and proximate to an outer periphery thereof.

Moreover, the water outlet gate unit 32 further includes an optical sensor assembly 34 for generating a light beam. The optical sensor assembly 34 is provided with a sensing area 341 that has a grooved shape and that is used for sensing the light beam. The optical sensing assembly 34 sends an electrical signal to the pivot motor 325 according to the light beam sensed by the sensing area 341 so as to control the operation of the pivot motor 325.

The outer periphery of the turntable portion 31 of the rotating member (323a) extends into the sensing area 341. The rotating member (323a) can be driven by the pivot motor 325 to rotate between a minimum rotation position and a maximum rotation position. When the rotating member (323a) is located in the minimum rotation position, as shown in FIG. 7, the drive member (321a) does not contact the stopper 313, and the stopper 313 is located in the water stop position. When the rotating member (323a) is located in the maximum rotation position, as shown in FIG. 8, the drive member (321a) pushes upward the stopper 313 to move the stopper 313 away from the water outlet hole 310 and be located in the water discharge position.

When the rotating member (323a) rotates between the minimum rotation position and the maximum rotation position, the light beam is blocked by the outer periphery of the turntable portion 331 and cannot be sensed by the sensing area 341, so that the pivot motor 325 continuously drive the rotating member (323a) to rotate. When the rotating member (323a) is located in the minimum rotation position or the maximum rotation position, the light beam can pass through the arc-shaped groove 302 and be sensed by the sensing area 341. At this time, the pivot motor 325 stops its operation, and the stopper 313 stays at the water stop position or the water discharge position.

Hence, through the configuration of the optical sensor assembly 34, the operation of the pivot motor 325 can be precisely controlled through optical sensing, so that the stopper 313 can accurately stay at the water discharge position or the water stop position. In comparison with the mechanical start switch 328 in the first embodiment, the water outlet device 3 of the second embodiment is more sensitive in operation and can prevent the occurrence of liquid leakage.

In the second embodiment, the shape of the groove 302 is arc shape, but is not limited thereto. In other implementations of this embodiment, any shape of the groove 302 is acceptable, as long as it can allow the light beam to pass the re through when the rotating member (323a) is rotated to the minimum rotation position or the maximum rotation position. For example, a circular groove or a groove of other shapes may be provided in each area corresponding to the minimum rotation position and the maximum rotation position.

In the second embodiment, when the rotating member (323a) is rotated to the minimum rotation position or the maximum rotation position, the light beam can pass through the groove 302 and be sensed by the sensing area 341; and, when the rotating member (323a) rotates between the minimum rotation position and the maximum rotation position, the light beam is blocked and cannot be sensed by the sensing area 341. However, in other implementations of this embodiment, it is not limited thereto. As long as the sensing area 341 can accurately detect the rotation position of the rotating member (323a) and transmit the corresponding electrical signal to the pivot motor 325, any position of the rotating member (323a) may be possible.

The water outlet gate unit 32 may also be designed as: When the rotating member (323a) is rotated to the minimum rotation position or the maximum rotation position, the light beam is blocked and cannot be sensed by the sensing area 341; and, when the rotating member (323a) rotates between the minimum rotation position and the maximum rotation position, the light beam can pass through the groove 302 and be sensed by the sensing area 341.

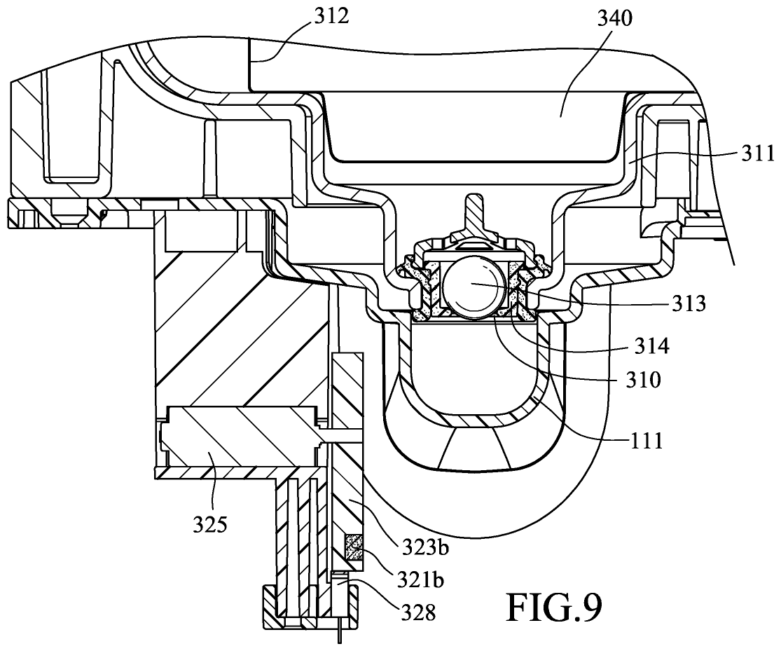

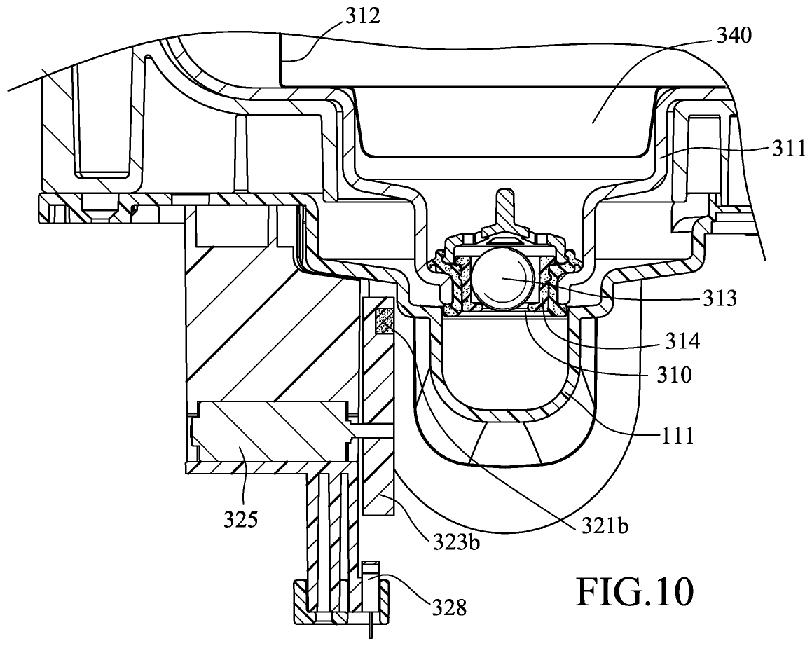

Referring to FIGS. 9 and 10, the third embodiment of the automatic water dispenser according to this disclosure is substantially identical to the first embodiment. Particularly, the water outlet gate unit 32 includes a drive member (321b), a rotating member (323b), a pivot motor 325, and a start switch 328. However, in the third embodiment, the drive member (321b) is made of a magnetic material, is disposed at an end portion of the rotating member (323b), and can be driven by the rotating member (323b) to rotate therewith. The stopper 313 is made of a magnetically attractive material, such as a steel or iron ball, is disposed in proximity to the drive member (321b), and can be driven to move by the magnetic force of the drive member (321b).

The rotating member (323b) can be driven by the pivot motor 325 to rotate between a first position and a second position. When the rotating member (323b) is located in the first position, the drive member (321b) is away from the stopper 311, and the stopper 311 naturally moves downward due to gravity to block the water outlet hole 310 and be located at the water stop position. Further, under the action of the magnetic force, the stopper 313 can tightly seal the water outlet hole 310 and can be prevented from shaking during moving or handling which can cause leakage of the liquid.

When the rotating member (323b) is located in the second position, the drive member (321b) is driven to move upward and relatively close to the stopper 311, and the stopper 313 is driven by the magnetic attraction force to move in the direction of the drive member (321b) and away from the water outlet hole 310 so as to shift to the water discharge position.

The function of the start switch 328 of the third embodiment is similar to that of the first embodiment, so that a detailed description thereof is omitted herein for the sake of brevity.

By designing the drive member (321b) as being made of a magnetic material, the stopper 313 made of magnetically attractive material can be controlled to shift between the water stop position and the water discharge position by a non-contact method, so that, not only the wear and tear caused by constant impact between the components can be reduced, but also the leakage problem can be further prevented.

In the third embodiment, the drive member (321b) is made of a magnetic material, such as rubidium iron boron magnet, but is not limited thereto. In other implementations of this embodiment, the drive member (321b) may be configured as an electromagnet.

In summary, through the containment unit 31 of the water outlet device 3 of the automatic water dispenser of this disclosure, a brewable product (not shown) can be brewed, and after the brewing is completed, the water outlet gate unit 32 is used to allow the brewed beverage to flow out of the containment unit 31. Further, if no brewable product is placed in the containment unit 31, only hot water will flow out of the containment unit 31. Hence, the automatic water dispenser of this disclosure can have hot water supply and brewing functions at the same time. Therefore, the object of this disclosure can indeed be achieved.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A water outlet device suitable for containing and discharging liquid, comprising:
a containment unit including a containment seat for containing the liquid and having a bottom portion formed with a water outlet hole, and a stopper located in said containment seat and movably disposed in said water outlet hole, said stopper being capable of blocking said water outlet hole for preventing the liquid from flowing out of said water outlet hole; and
a water outlet gate unit disposed below said containment unit and including a drive member that drives said stopper to move between a water stop position, in which said stopper blocks said water outlet hole, and a water discharge position, in which said stopper is moved away from said water outlet hole for allowing the liquid to flow through said water outlet hole.

2. The water outlet device as claimed in claim 1, wherein said drive member is a push rod, said water outlet gate unit further including a rotating member abutting against said drive member and having a cylindrical shape, said rotating member having a protruding portion protruding from an outer periphery thereof, and wherein, when said rotating member rotates in a rotational direction, said protruding portion pushes said drive member to move upward, which in turn, pushes said stopper to move from said water stop position to said water discharge position.

3. The water outlet device as claimed in claim 2, wherein said water outlet gate unit further includes a pivot motor and a start switch for controlling said pivot motor, said rotating member being pivotally connected to said pivot motor and can be driven by said pivot motor to rotate in the rotational direction.

4. The water outlet device as claimed in claim 2, wherein said water outlet gate unit further includes a fixed frame for extension of said drive member there through, an abutment ring sleeved on said drive member and located in said fixed frame, and an elastic member sleeved on said drive member and having two opposite ends respectively abutting against said fixed frame and said abutment ring, and wherein, when said drive member drives said stopper to move from said water stop position to said water discharge position, said elastic member is compressed by said fixed frame and said abutment ring to store an elastic restoring force.

5. The water outlet device as claimed in claim 1, wherein said drive member is a push rod, said water outlet gate unit further including a rotating member having a circular disk shape, said rotating member having a turntable portion, and a driven portion protruding axially from said turntable portion, said drive member having a bottom end provided with a through slot for connection with said driven portion, said rotating member being rotated to drive said drive member to push said stopper so as to move said stopper from said water stop position to said water discharge position.

6. The water outlet device as claimed in claim 5, wherein said turntable portion has a groove, said water outlet gate unit further including a pivot motor, and an optical sensor assembly for generating a light beam and provided with a sensing area for sensing the light beam, said rotating member being pivotally connected to said pivot motor and being driven by said pivot motor to rotate between a minimum rotation position and a maximum rotation position, said optical sensor assembly sending an electrical signal to said pivot motor according to the light beam sensed by said sensing area so as to control the operation of said pivot motor, and wherein, when said rotating member is located in said minimum rotation position or said maximum rotation position, the light beam can pass through said groove and be sensed by said sensing area, and said optical sensor assembly sends an electrical signal to said pivot motor to stop the operation thereof to thereby place said stopper in said water stop position or said water discharge position.

7. The water outlet device as claimed in claim 6, wherein said groove is located in proximity to an outer periphery of said turntable portion and having an arc shape, said groove extending axially through said turntable portion for allowing the light beam to pass therethrough.

8. The water outlet device as claimed in claim 1, wherein said water outlet gate unit further includes a rotating member, a pivot motor, and a start switch for controlling said pivot motor, said drive member being made of a magnetic material and being disposed at an end portion of said rotating member to rotate therewith, said stopper being made of a magnetically attractive material, said rotating member being pivotally connected to said pivot motor and being driven by said pivot motor to rotate, and wherein, when said rotating member is driven by said pivot motor to rotate so as to move upward said drive member, said stopper is driven to move by magnetic force of said drive member from said water stop position to said water discharge position.

9. The water outlet device as claimed in claim 1, wherein said containment unit further includes a filter disposed in said containment seat for receiving a brewable product and for allowing the brewable product to be brewed in said containment seat.

10. The water outlet device as claimed in claim 1, wherein said stopper is a spherical body, and said containment unit further includes a sealing ring disposed on an inner periphery of said bottom portion of said containment seat that defines said water outlet hole, and wherein, when said stopper is not driven by said drive member to move away from said water outlet hole, said stopper is located on top of said sealing ring.

11. An automatic water dispenser suitable for containing and discharging liquid, comprising:
a housing including a main body seat portion, a main body cover portion disposed on a top end of said main body seat portion, a removable seat portion removably mounted on said main body cover portion, and a top cover assembly covering a top end of said removable seat portion, said top cover assembly including a top cover that has a plurality of water injection holes provided on a bottom surface thereof;
a water supply device including a water storage unit disposed in said main body seat portion for containing the liquid, and a water delivery unit connected to said water storage unit and said top cover for delivering the liquid from said water storage unit to said top cover; and
a water outlet device as claimed in claim 1, said water outlet device being disposed in said housing, said containment unit of said water outlet device being removably disposed in said removable seat portion;
wherein said water injection holes in said top cover are configured for injecting the liquid to said water outlet device.

12. The automatic water dispenser as claimed in claim 11, wherein said drive member is a push rod, said water outlet gate unit further including a rotating member abutting against said drive member and having a cylindrical shape, said rotating member having a protruding portion formed on an outer periphery thereof, and wherein, when said rotating member rotates in a rotational direction, said protruding portion pushes said drive member to move upward, which in turn, pushes said stopper to move from said water stop position to said water discharge position.

13. The automatic water dispenser as claimed in claim 12, wherein said water outlet gate unit further includes a pivot motor and a start switch for controlling said pivot motor, said rotating member being pivotally connected to said pivot motor and can be driven by said pivot motor to rotate in the rotational direction.

14. The automatic water dispenser as claimed in claim 12, wherein said water outlet gate unit further includes a fixed frame for extension of said drive member there through, an abutment ring sleeved on said drive member and located in said fixed frame, and an elastic member sleeved on said drive member and having two opposite ends respectively abutting against said fixed frame and said abutment ring, and wherein, when said drive member drives said stopper to move from said water stop position to said water discharge position, said elastic member is compressed by said fixed frame and said abutment ring to store an elastic restoring force.

15. The automatic water dispenser as claimed in claim 11, wherein said drive member is a push rod, said water outlet gate unit further including a rotating member having a circular disk shape, said rotating member having a turntable portion, and a driven portion protruding axially from said turntable portion, said drive member having a bottom end provided with a through slot for connection with said driven portion, said rotating member being rotated to drive said drive member to push said stopper so as to move said stopper from said water stop position to said water discharge position.

16. The automatic water dispenser as claimed in claim 15, wherein said turntable portion has a groove, said water outlet gate unit further including a pivot motor, and an optical sensor assembly for generating a light beam and provided with a sensing area for sensing the light beam, said rotating member being pivotally connected to said pivot motor and being driven by said pivot motor to rotate between a minimum rotation position and a maximum rotation position, said optical sensor assembly sending an electrical signal to said pivot motor according to the light beam sensed by said sensing area so as to control the operation of said pivot motor, and wherein, when said rotating member is located in said minimum rotation position or said maximum rotation position, the light beam can pass through said groove and be sensed by said sensing area, and said optical sensor assembly sends an electrical signal to said pivot motor to stop the operation thereof to thereby place said stopper in said water stop position or said water discharge position.

17. The automatic water dispenser as claimed in claim 16, wherein said groove is located in proximity to an outer periphery of said turntable portion and having an arc shape, said groove extending axially through said turntable portion for allowing the light beam to pass therethrough.

18. The automatic water dispenser as claimed in claim 11, wherein said water outlet gate unit further includes a rotating member, a pivot motor, and a start switch for controlling said pivot motor, said drive member being made of a magnetic material and being disposed at an end portion of said rotating member to rotate therewith, said stopper being made of a magnetically attractive material, said rotating member being pivotally connected to said pivot motor and being driven by said pivot motor to rotate, and wherein, when said rotating member is driven by said pivot motor to rotate so as to move upward said drive member, said stopper is driven to move by magnetic force of said drive member from said water stop position to said water discharge position.

19. The automatic water dispenser as claimed in claim 11, wherein said containment unit further includes a filter disposed in said containment seat for receiving a brewable product and for allowing the brewable product to be brewed in said containment seat.
